(19) United States
(12) Patent Application Publication
(10) Pub. No.: US 2026/0113675 A1
(43) Pub. Date: Apr. 23, 2026

(54) NETWORK ROAMING METHOD FOR MULTI-BAND TERMINALS, ELECTRONIC DEVICE AND COMPUTER READABLE STORAGE MEDIUM

(71) Applicant: Nanning FuLian FuGui Precision Industrial Co., Ltd., Nanning (CN)

(72) Inventor: TIAN-CHI LI, New Taipei (TW)

(21) Appl. No.: 18/919,857

(22) Filed: Oct. 18, 2024

(51) Int. Cl. H04W 36/08; H04W 36/00; H04W 36/30

(52) U.S. Cl. CPC H04W 36/08; H04W 36/0083; H04W 36/304

(57) ABSTRACT

A network roaming method for multi-band terminals is disclosed. A multi-band client connects to a first multi-band AP. When the first multi-band AP determines that a variation degree of a signal strength between the first multi-band AP and the multi-band client meets a rescanning threshold, the first multi-band AP and a second multi-band base station transmit to each other signal strength information of the multi-band client. When the first multi-band AP determines that a signal switching operation occurs in at least one frequency band between the multi-band client and a second multi-band AP, the first multi-band AP and the second multi-band AP transmit connection information of the multi-band client to each other that at least one frequency band of the multi-band client is connected to the second multi-band AP.

### FIELD

The disclosure relates to a network roaming method, and more particularly to a network roaming method for multi-band terminals.

### BACKGROUND

With increasing demand for higher bandwidths in wireless local area networks (WLANs), advances in WLAN may support devices with multiple frequency channels, channel bandwidths, etc. Devices with multiple wireless frequency bands may provide different but complementary characteristics in terms of coverage range and throughput.

The seventh generation of Wi-Fi wireless network (Wi-Fi 7) has gradually become the next generation of major wireless network communication technology. Wi-Fi 7 can reach speeds of up to 30 gigabits per second (Gbits), which is three times the maximum rate of 9.6 Gbps of the sixth-generation Wi-Fi wireless network (Wi-Fi 6). Compared with Wi-Fi 6, Wi-Fi 7 can support up to 16 data streams. In addition to the traditional two frequency bands of 2.4 gigahertz (GHz) and 5 GHz, Wi-Fi 7 also supports the 6 GHz frequency band, and the three frequency bands can work at the same time.

However, in the existing mesh network of the Wi-Fi 6 system and the Wi-Fi 7 system, when a multi-band client switches between different access point nodes, there may be network connection interruptions and sticky connections, thereby preventing truly seamless switching from being achieved.

### BRIEF DESCRIPTION OF THE DRAWINGS

Many aspects of the present disclosure can be better understood with reference to the following figures. The components in the figures are not necessarily drawn to scale, the emphasis instead being placed upon clearly illustrating the principles of the present disclosure. Moreover, in the drawings, like reference numerals designate corresponding parts throughout the several views. Implementations of the present technology will now be described, by way of embodiments, with reference to the attached figures, wherein:

FIG. 1 is a schematic diagram of an embodiment of a network roaming system for multi-band terminals of the present disclosure;

FIG. 2 is a flowchart of an embodiment of a network roaming method for multi-band terminals of the present disclosure;

FIG. 3 is a schematic diagram of an embodiment of an application of network roaming for multi-band terminals of the present disclosure;

FIG. 4 is a block diagram of an embodiment of the hardware architecture of an electronic device using the method of the present disclosure; and

FIG. 5 is a block diagram of an embodiment of functional blocks of an electronic device of the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “comprising,” when utilized, means “including, but not necessarily limited to”; it specifically indicates open-ended inclusion or membership in the so-described combination, group, series, and the like.

An embodiment of a network roaming method for multi-band terminals is applied to a mesh network for Wi-Fi systems and handles roaming connections of multi-band client wireless networking devices. When the wireless signal quality of the wireless networking devices gradually deteriorates due to movements, the multi-link operation (MLO) mode and multi-band “access point-station (AP-STA)” connection function supported by the multi-band client can be used for pre-roaming the 2.4 GHz band signals with stronger anti-interference ability to an AP with better signal strength to establish another AP-STA connection. Therefore, when the wireless networking device moves to a signal range of a main frequency band, 5 GHz or 6 GHz, and a roaming condition is triggered, the wireless networking device connects to the main frequency band to achieve uninterrupted communication.

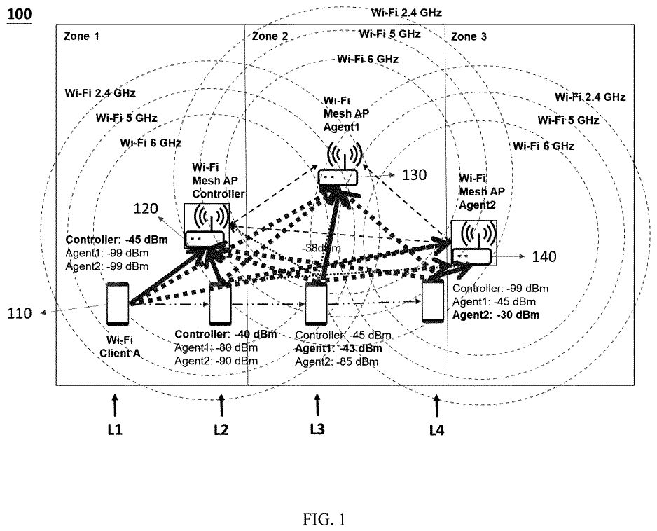

FIG. 1 is a schematic diagram of an embodiment of a network roaming system for multi-band terminals of the present disclosure. An embodiment of the network roaming system for multi-band terminals 100 comprises a multi-band client 110 (i.e. the Wi-Fi Client A), a multi-band access point (AP) controller 120 (i.e. the Wi-Fi Client A), a multi-band AP 130 (i.e. Wi-Fi Mesh AP Agent1) and a multi-band AP 140 (i.e. Wi-Fi Mesh AP Agent2). All of the multi-band client 110, the multi-band AP controller 120, the multi-band AP 130 and the multi-band AP 140 provide 2.4 GHz, 5 GHz and 6 GHz bands.

As shown in FIG. 1, when the multi-band client 110 resides in an initial position L1, the signal strength between it and the multi-band AP controller 120 is −45 decibel milliwatt (dBm), the signal strength between it and 130 and the multi-band AP 130 is −99 dBm, and the signal strength between it and 130 and the multi-band AP 140 is −99 dBm. When the multi-band client 110 moves to the next position L2, the signal strength between it and the multi-band AP controller 120 is −40 dBm, the signal strength between it and 130 and the multi-band AP 130 is −80 dBm, and the signal strength between it and 130 and the multi-band AP 140 is −90 dBm, and so on.

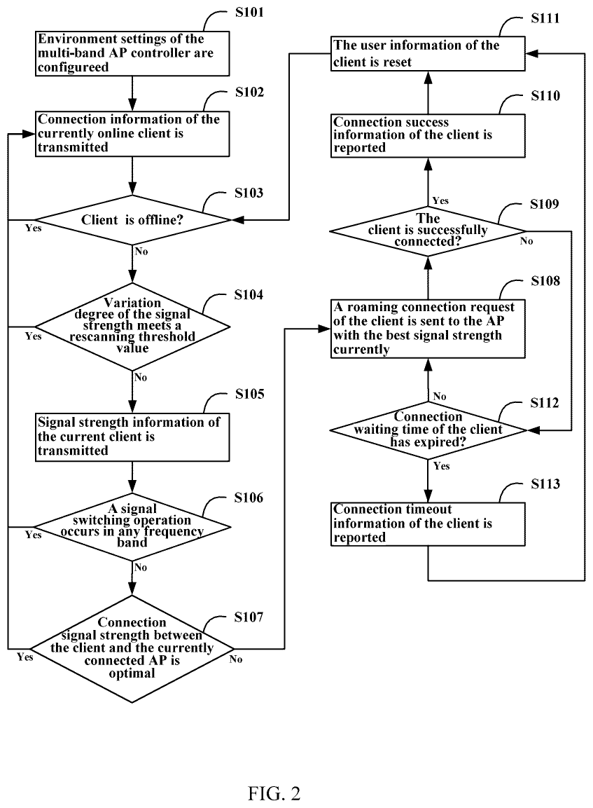

FIG. 2 is a flowchart of an embodiment of a network roaming method for multi-band terminals of the present disclosure. According to different needs, the order of the steps in the flowchart can be changed, and some steps can be omitted.

Referring to FIG. 1, in step S101, a user first configures environment settings of the multi-band AP controller 120, for example, configuring a mesh network including the multi-band AP controller 120, the multi-band AP 130 and the multi-band AP 140 and related settings.

In step S102, when the multi-band client 110 enters a connection range of the mesh network, the multi-band client 110 is connected to one of the multi-band APs, for example, the multi-band AP controller 120. In an embodiment of the present invention, a multi-band device provides multiple frequency bands available for connection, such as the 2.4 GHz band, the 5 GHz band and the 6 GHz band. At this time, the three frequency bands of the multi-band client 110 are respectively connected to the same frequency band of the multi-band AP controller 120. It should be noted that the multi-band AP controller 120 has a central control and management function of the mesh network and provides a networking function to the multi-band clients 110.

Next, the multi-band AP controller 120 and the multi-band APs 130 and 140 transmit connection information of the currently online client, for example, the multi-band client 110, to each other through the Institute of Electrical and Electronics Engineers (IEEE) 1905.1. The connection information at least includes signal strengths (e.g., Received Signal Strength Indicator, RSSI) of the multi-band client 110 relative to different APs in each frequency band and variation degrees of the signal strengths.

Referring to FIG. 1, regarding the 2.4 GHz band, when the multi-band client 110 is moving to the right, the signal strengths of the multi-band client 110 between the multi-band AP controller 120 and the multi-band APs 130 and 140 from the position L1 to the position L4 are: [−45, −99, −99], [−40, −80, −90], [−45, −43, −85] and [−99, −45, −30], and the variation degrees of the signal strengths are respectively [+5, +19, +9], [−5, +37, +5] and [−54, −2, +55].

In step S103, the multi-band AP controller 120 determines whether the multi-band client 110 is offline based on the connection information, and, if so, the process proceeds to step S102 to wait for a new multi-band client to connect.

In step S104, if the multi-band client 110 is not offline, the multi-band AP controller 120 determines whether the variation degree of the signal strength between the multi-band client 110 and the multi-band AP controller 120 meets a rescanning threshold value, and, if not, the process proceeds to step S102.

In this embodiment, the rescanning threshold value of the 2.4 GHz band is +/−5 dBm, the rescanning threshold value of the 5 GHz band is +/−4 dBm, and the rescanning threshold value of the 6 GHz band is +/−3 dBm. In other words, when the signal strength of the 2.4 GHz band increases or decreases by at least 5 dBm, the multi-band AP controller 120 sends a rescanning signal request to the multi-band APs 130 and 140, so that the multi-band AP controller 120 and the multi-band APs 130 and 140 scan and obtain the signal strengths between them and the multi-band client 110.

In step S105, if the variation degree of the signal strength between the multi-band client 110 and the multi-band AP controller 120 meets the rescanning threshold value, the multi-band AP controller 120 and each of the multi-band APs (e.g., the multi-band APs 130 and 140) mutually transmit signal strength information of the current multi-band client (e.g., the multi-band client 110) through IEEE 1905.1.

In step S106, the multi-band AP controller 120 determines whether a signal switching operation occurs in any frequency band between the multi-band client 110 and any of the multi-band APs 130 and 140. If yes, it means that at least one frequency band signal of the multi-band client 110 is switched from the multi-band AP controller 120 to the multi-band AP 130 or the multi-band AP 140 for connection. Therefore, the multi-band AP controller 120 and the multi-band AP 130 or the multi-band AP 140 transmit the connection information of the multi-band client 110 to each other through IEEE 1905.1 (step S102).

Referring to FIG. 1, regarding the 2.4 GHz band, when the multi-band client 110 is moving from the position L2 to the position L3, the signal strengths of the multi-band client 110 between the multi-band AP controller 120 and the multi-band APs 130 and 140 from the position L1 to the position L4 are changed from [−40, −80, −90] to [−45, −43, −85]. At this time, the signal strength between the multi-band client 110 and the multi-band AP 130 is greater than the signal strengths between the multi-band client 110 and the multi-band AP controller 120 and the multi-band AP 140, and therefore, the 2.4 GHz band of the multi-band client 110 is changed to be connected to the multi-band AP 130, while the 5 GHz band and the 6 GHz band remain unchanged and are still connected to the multi-band AP controller 120.

In step S107, if the signal switching operation does not occur in any frequency band between the multi-band client 110 and any of the multi-band APs 130 and 140, the multi-band base AP 120 determines whether the connection signal strength between the multi-band client 110 and the currently connected AP, for example, the multi-band AP controller 120, is optimal, and, if so, the process proceeds to step S102.

In step S108, if the connection signal strength between the multi-band client 110 and the currently connected AP, for example, the multi-band AP controller 120, is not optimal, the multi-band AP controller 120 sends a roaming connection request of the multi-band client 110 to the AP with the best signal strength currently, for example, the multi-band AP 130, and enables the multi-band client 110 to connect to the multi-band AP 130.

In step S109, the multi-band AP 130 determines whether the multi-band client 110 is successfully connected.

In step S110, if the multi-band client 110 is successfully connected, the multi-band AP 130 reports connection success information of the multi-band client 110 to the multi-band AP controller 120 through IEEE 1905.1.

In step S111, the multi-band AP controller 120 resets the user information of the multi-band client 110 and the process proceeds to step S103.

In step S112, if the multi-band client 110 fails to connect, the multi-band AP controller 120 determines whether the connection waiting time of the multi-band client 110 has expired, and, if not, the process proceeds to step S108 to send another roaming connection request.

In step S113, if the connection waiting time of the multi-band client 110 has expired, the multi-band AP 130 reports connection timeout information of the multi-band client 110 to the multi-band AP controller 120 through IEEE 1905.1.

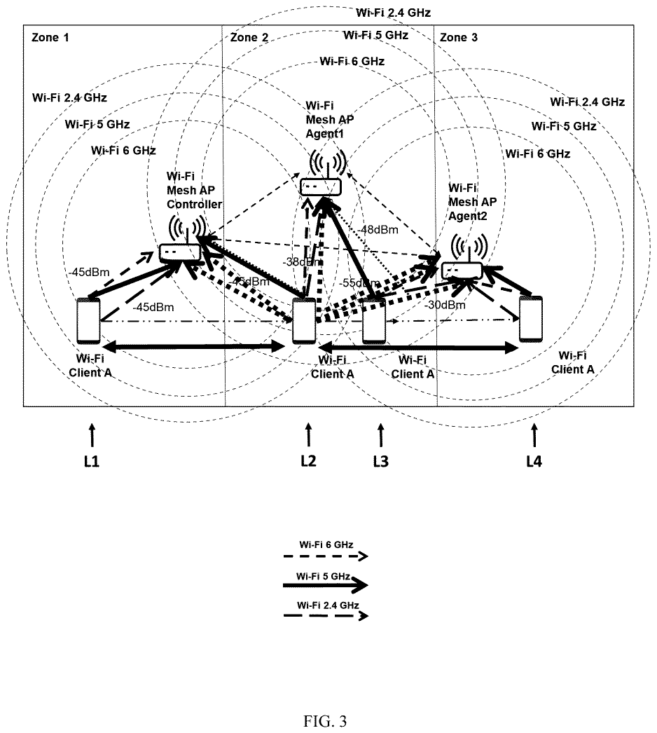

FIG. 3 is a schematic diagram of an embodiment of an application of network roaming for multi-band terminals of the present disclosure.

When the multi-band client 110 resides at the position L1 within the signal ranges of the 2.4 GHz band, 5 GHz band and 6 GHz band of the multi-band AP controller 120, the 2.4 GHz band, 5 GHz band and 6 GHz band of the multi-band client 110 are connected to the multi-band AP controller 120.

When the multi-band client 110 moves to the position L2 within the signal ranges of the 2.4 GHz bands, 5 GHz bands and 6 GHz bands of the multi-band AP controller 120 and the multi-band AP 130, the signal strengths of the 2.4 GHz frequency band and the 6 GHz frequency band between the multi-band client 110 and the multi-band AP 130 is greater than the signal strengths of the 2.4 GHz band and the 6 GHz and between the multi-band client 110 and the multi-band AP controller 120, and the signal strength of the 5 GHz band between the multi-band client 110 and the multi-band AP 130 is smaller than the signal strength of the 5 GHz band between the multi-band client 110 and the multi-band AP controller 120. Therefore, the 2.4 GHz band and the 6 GHz band of the multi-band client 110 are connected to the multi-band AP controller 120, and the 5 GHz band is still connected to the multi-band AP controller 120.

When the multi-band client 110 moves to the position L3 within the signal ranges of the 2.4 GHz band and 5 GHz band of the multi-band AP 130 and the signal ranges of the 2.4 GHz band, 5 GHz band and 6 GHz band of the multi-band AP 140, the signal strength of the 2.4 GHz band between the multi-band client 110 and the multi-band AP 140 is greater than the signal strength of the 2.4 GHz band between the multi-band client 110 and the multi-band AP 130 and the signal strength of the 5 GHz band between the multi-band client 110 and the multi-band AP 140 is smaller than the signal strength of the 5 GHz band between the multi-band client 110 and the multi-band AP 130. Therefore, the 5 GHz band of the multi-band client 110 is connected to the multi-band AP controller 130, and the 2.4 GHz and and the 6 GHz band are connected to the multi-band AP 140.

When the multi-band client 110 resides at the position L1 within the signal ranges of the 2.4 GHz band, 5 GHz band and 6 GHz band of the multi-band AP 140, the 2.4 GHz band, 5 GHz band and 6 GHz band of the multi-band client 110 are connected to the multi-band AP 140.

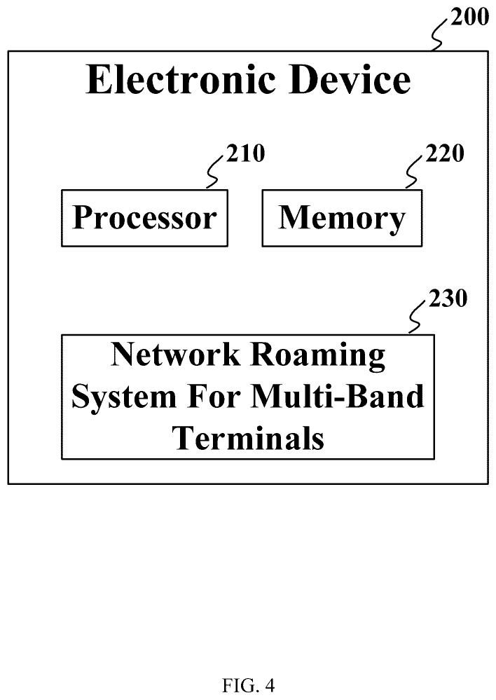

FIG. 4 is a block diagram of an embodiment of the hardware architecture of an electronic device using the network roaming method for multi-band terminals of the present disclosure. The electronic device 200 may be, but is not limited to, connected to a processor 210, a memory 220, and a network roaming system for multi-band terminals 230 via system buses. The electronic device 200 shown in FIG. 4 may include more or fewer components than those illustrated or may combine certain components.

The memory 220 stores a computer program, such as the network roaming system for multi-band terminals 230, which is executable by the processor 210. When the processor 210 executes the network roaming system for multi-band terminals 230, the blocks in one embodiment of the booting mode configuration method applied in the electronic device 200 are implemented, such as blocks S101 to S113 shown in FIG. 2.

It will be understood by those skilled in the art that FIG. 4 is merely an example of the electronic device 200 and does not constitute a limitation to the electronic device 200. The electronic device 200 may include more or fewer components than those illustrated or may combine certain components. The electronic device 200 may also include input and output devices, network access devices, buses, and the like.

The processor 210 may be a central processing unit (CPU), or other general-purpose processors, a digital signal processor (DSP), an application specific integrated circuit (ASIC), a Field-Programmable Gate Array (FPGA), or another programmable logic device, discrete gate or transistor logic device, discrete hardware components, or the like. The processor 210 may be a microprocessor or other processor known in the art.

The memory 220 can be used to store the network roaming system for multi-band terminals 230 and/or modules/units by running or executing computer programs and/or modules/units stored in the memory 220. The memory 220 may include a storage program area and a storage data area. In addition, the memory 220 may include a high-speed random access memory, a non-volatile memory such as a hard disk, a plug-in hard disk, a smart memory card (SMC), and a secure digital (SD) card, flash card, at least one disk storage device, flash device, or another volatile solid state storage device.

The network roaming system for multi-band terminals 230 can be partitioned into one or more modules/units that are stored in the memory 220 and executed by the processor 210. The one or more modules/units may be a series of computer program instructions capable of performing particular functions of the network roaming system for multi-band terminals 230.

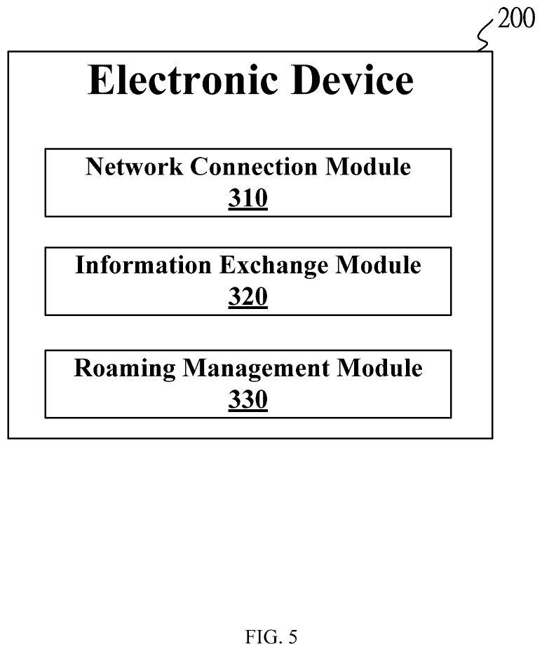

FIG. 5 is a schematic diagram of an embodiment of functional blocks of the electronic device using the method of the present disclosure.

The electronic device 200, such as a multi-band AP controller, comprises a network connection module 310, an information exchange module 320 and a roaming management module 330.

Referring to FIG. 1, a user first configures environment settings of the multi-band AP controller 120, for example, configuring a mesh network including the multi-band AP controller 120, the multi-band AP 130 and the multi-band AP 140 and related settings. When the multi-band client 110 enters a connection range of the mesh network, the multi-band client 110 is connected to one of the multi-band APs, for example, the multi-band AP controller 120. Currently, the network connection module 310 obtains a connection request from the multi-band client 110 and accepts the connection from the multi-band client 110 according to the connection request. The three frequency bands, for example, the 2.4 GHz band, the 5 GHz band and the 6 GHz band. of the multi-band client 110 are respectively connected to the same frequency band of the multi-band AP controller 120.

The information exchange module 320 and the multi-band APs 130 and 140 transmit connection information of a currently online client, for example, the multi-band client 110, to each other through IEEE 1905.1. The connection information at least includes the signal strength (e.g., RSSI) of the multi-band client 110 relative to different APs in each frequency band and the variation degree of the signal strength.

The roaming management module 330 determines whether the multi-band client 110 is offline based on the connection information, and, if the multi-band client 110 is not offline, then determines whether the variation degree of the signal strength between the multi-band client 110 and the multi-band AP controller 120 meets a rescanning threshold value.

In this embodiment, the rescanning threshold value of the 2.4 GHz band is +/−5 dBm, the rescanning threshold value of the 5 GHz band is +/−4 dBm, and the rescanning threshold value of the 6 GHz band is +/−3 dBm. In other words, when the signal strength of the 2.4 GHz band increases or decreases by at least 5 dBm, the multi-band AP controller 120 sends a rescanning signal request to the multi-band APs 130 and 140, so that the multi-band AP controller 120 and the multi-band APs 130 and 140 scan and obtain the signal strengths between them and the multi-band client 110.

If the variation degree of the signal strength between the multi-band client 110 and the multi-band AP controller 120 meets the rescanning threshold value, the information exchange module 320 and each of the multi-band APs (e.g., the multi-band APs 130 and 140) mutually transmit signal strength information of the current multi-band client (e.g., the multi-band client 110) through IEEE 1905.1.

The roaming management module 330 determines whether a signal switching operation occurs in any frequency band between the multi-band client 110 and any of the multi-band APs 130 and 140. If the signal switching operation does not occur in any frequency band between the multi-band client 110 and any of the multi-band APs 130 and 140, the roaming management module 330 determines whether the connection signal strength between the multi-band client 110 and the currently connected AP (for example, the multi-band AP controller 120) is optimal.

If the connection signal strength between the multi-band client 110 and the currently connected AP, for example, the multi-band AP controller 120, is not optimal, the roaming management module 330 sends a roaming connection request of the multi-band client 110 to the AP with the best signal strength currently, for example, the multi-band AP 130, and enables the multi-band client 110 to connect to the multi-band AP 130.

The multi-band AP 130 determines whether the multi-band client 110 is successfully connected. If the multi-band client 110 is successfully connected, the information exchange module 320 obtains the connection success information of the multi-band client 110 from the multi-band AP 130 through IEEE 1905.1.

If the multi-band client 110 fails to connect, the roaming management module 330 determines whether the connection waiting time has expired. If the connection waiting time times out, the information exchange module 320 obtains connection timeout information of the multi-band client 110 from the multi-band AP 130 through IEEE 1905.1.

It is to be understood, however, that even though numerous characteristics and advantages of the present disclosure have been set forth in the foregoing description, together with details of the structure and function of the present disclosure, the disclosure is illustrative only, and changes may be made in detail, especially in matters of shape, size, and arrangement of parts within the principles of the present disclosure to the full extent indicated by the broad general meaning of the terms in which the appended claims are expressed.

What is claimed is:

1. A network roaming method for multi-band terminals executable by a first multi-band access point (AP), comprising:
when a multi-band client enters a connection range of a mesh network, enabling the multi-band client to connect to the first multi-band base station, wherein the mesh network comprises at least the first multi-band AP and a second multi-band AP;
mutually transmitting, by the first multi-band AP and the second multi-band AP, connection information of at least one currently online client to each other;
determining, by the first multi-band AP, whether the multi-band client is offline based on the connection information, wherein
if the multi-band client is determined not offline, determining, by the first multi-band AP, whether a variation degree of a signal strength between the multi-band client and the first multi-band AP meets a rescanning threshold value, wherein
if the variation degree of the signal strength is determined meeting the rescanning threshold, mutually transmitting, by the first multi-band AP and the second multi-band AP, signal strength information of the multi-band client; and
determining, by the first multi-band AP, whether a signal switching operation occurs in any frequency band between the multi-band client and the second multi-band AP, wherein
if the signal switching operation is determined to be occurring in at least one frequency band, mutually transmitting, by the first multi-band AP and the second multi-band AP, the connection information of the multi-band client, wherein one of the frequency bands of the multi-band client is connected to the second multi-band AP.

2. The method of claim 1, further comprising:
if no signal switching operation is determined to be occurring in any frequency band, determining, by the first multi-band AP, whether a connection signal strength between the first multi-band AP and the multi-band client is optimal, wherein
if the connection signal strength between the first multi-band AP and the multi-band client is determined not optimal, enabling the first multi-band base station to send a roaming connection request of the multi-band client to the second multi-band AP and enabling the multi-band client to connect to the second multi-band AP.

3. The method of claim 2, further comprising:
determining, by the second multi-band AP, whether the multi-band client is successfully connected;
if the multi-band client is successfully connected, reporting, by the second multi-band AP, connection success information of the multi-band client to the first multi-band AP; and
resetting, by the first multi-band AP, user information of the multi-band client.

4. The method of claim 3, further comprising:
if the multi-band client fails to connect, determining, by the second multi-band AP, whether a connection waiting time of the multi-band client has expired; and
if the connection waiting time has expired, reporting, by the second multi-band AP, the connection timeout information of the multi-band client to the first multi-band AP.

5. An electronic device, which includes a memory, a processor, and a serial number length adjustment program stored in the memory and operable on the processor, wherein the serial number length adjustment program is executed by the processor to implement following instructions:
when a multi-band client enters a connection range of a mesh network, enabling the multi-band client to connect to the first multi-band base station, wherein the mesh network comprises at least the first multi-band AP and a second multi-band AP;
mutually transmitting, by the first multi-band AP and the second multi-band AP, connection information of at least one currently online client to each other;
determining, by the first multi-band AP, whether the multi-band client is offline based on the connection information, wherein
if the multi-band client is determined not offline, determining, by the first multi-band AP, whether a variation degree of a signal strength between the multi-band client and the first multi-band AP meets a rescanning threshold value, wherein
if the variation degree of the signal strength is determined meeting the rescanning threshold, mutually transmitting, by the first multi-band AP and the second multi-band AP, signal strength information of the multi-band client; and
determining, by the first multi-band AP, whether a signal switching operation occurs in any frequency band between the multi-band client and the second multi-band AP, wherein
if the signal switching operation is determined to be occurring in at least one frequency band, mutually transmitting, by the first multi-band AP and the second multi-band AP, the connection information of the multi-band client, wherein one of the frequency bands of the multi-band client is connected to the second multi-band AP.

6. The device of claim 5, wherein the network roaming program is further executed by the processor to implement following instructions:
if no signal switching operation is determined to be occurring in any frequency band, determining, by the first multi-band AP, whether a connection signal strength between the first multi-band AP and the multi-band client is optimal, wherein
if the connection signal strength between the first multi-band AP and the multi-band client is determined not optimal, enabling the first multi-band base station to send a roaming connection request of the multi-band client to the second multi-band AP and enabling the multi-band client to connect to the second multi-band AP.

7. The device of claim 6, wherein the network roaming program is further executed by the processor to implement following instructions:
determining, by the second multi-band AP, whether the multi-band client is successfully connected;
if the multi-band client is successfully connected, reporting, by the second multi-band AP, connection success information of the multi-band client to the first multi-band AP; and
resetting, by the first multi-band AP, user information of the multi-band client.

8. The device of claim 7, wherein the network roaming program is further executed by the processor to implement following instructions:
if the multi-band client fails to connect, determining, by the second multi-band AP, whether a connection waiting time of the multi-band client has expired; and
if the connection waiting time has expired, reporting, by the second multi-band AP, the connection timeout information of the multi-band client to the first multi-band AP.

9. A non-transitory computer-readable storage medium storing game program which causes a computer to execute:
a process of, when a multi-band client enters a connection range of a mesh network, enabling the multi-band client to connect to the first multi-band base station, wherein the mesh network comprises at least the first multi-band AP and a second multi-band AP;
a process of mutually transmitting, by the first multi-band AP and the second multi-band AP, connection information of at least one currently online client to each other;
a process of determining, by the first multi-band AP, whether the multi-band client is offline based on the connection information;
a process of, if the multi-band client is not offline, determining, by the first multi-band AP, whether a variation degree of a signal strength between the multi-band client and the first multi-band AP meets a rescanning threshold value;
a process of, if the variation degree of the signal strength meets the rescanning threshold, mutually transmitting, by the first multi-band AP and the second multi-band AP, signal strength information of the multi-band client;
a process of determining, by the first multi-band AP, whether a signal switching operation occurs in any frequency band between the multi-band client and the second multi-band AP; and
a process of, if the signal switching operation occurs in at least one frequency band, mutually transmitting, by the first multi-band AP and the second multi-band AP, the connection information of the multi-band client, wherein one of the frequency bands of the multi-band client is connected to the second multi-band AP.

10. The non-transitory computer-readable storage medium of claim 9, wherein the game program causes the computer to further execute:
a process of, if no signal switching operation occurs in any frequency band, determining, by the first multi-band AP, whether a connection signal strength between the first multi-band AP and the multi-band client is optimal; and
a process of, if the connection signal strength between the first multi-band AP and the multi-band client is not optimal, enabling the first multi-band base station to send a roaming connection request of the multi-band client to the second multi-band AP and enabling the multi-band client to connect to the second multi-band AP.

11. The non-transitory computer-readable storage medium of claim 10, wherein the game program causes the computer to further execute:
a process of determining, by the second multi-band AP, whether the multi-band client is successfully connected;
a process of, if the multi-band client is successfully connected, reporting, by the second multi-band AP, connection success information of the multi-band client to the first multi-band AP; and
a process of resetting, by the first multi-band AP, user information of the multi-band client.

12. The non-transitory computer-readable storage medium of claim 11, wherein the game program causes the computer to further execute:
a process of, if the multi-band client fails to connect, determining, by the second multi-band AP, whether a connection waiting time of the multi-band client has expired; and
a process of, if the connection waiting time has expired, reporting, by the second multi-band AP, the connection timeout information of the multi-band client to the first multi-band AP.
